(19) United States
(12) Patent Application Publication
(10) Pub. No.: US 2004/0239527 A1
(43) Pub. Date: Dec. 2, 2004

(54) System for apprehending traffic signal violators

(76) Inventor: Young-Heum Kim, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/738,290

(22) Filed: Dec. 16, 2003

(30) Foreign Application Priority Data
May 27, 2003 (KR) 2003-33592

(51) Int. Cl. G08G 1/017

(52) U.S. Cl. 340/937; 348/149

(57) ABSTRACT

A system for apprehending vehicles violating a traffic signal comprises on-board equipment provided in vehicles that transmits speed information and license plate numbers of the vehicles. Roadside equipment receives the speed information and license plate numbers from the vehicles both before and after the vehicles enter an intersection. A signal light controller controls traffic signal lights at the intersection. A server center detects a vehicle violating a traffic signal on the basis of signals inputted from the roadside equipment and the signal light controller. An automated camera performs a photographing operation according to control of the server center and produces at least one image of the vehicle violating the traffic signal.

### CROSS-REFERENCE TO RELATED APPLICATIONS

This application claims priority of Korean Application No. 10-2003-0033592, filed on May 27, 2003, the disclosure of which is incorporated fully herein by reference.

### FIELD OF THE INVENTION

The present invention relates to a system for apprehending traffic signal violators and, more particularly, to an automated system for apprehending traffic signal violators at an intersection or the like.

### BACKGROUND OF THE INVENTION

In general, in order for traffic to flow smoothly and freely, traffic signal lights are installed at an intersection, or the like, for vehicles to either stop, drive straight or make a right or left turn according to the traffic signal light in order to optimize traffic flow and minimize traffic jams.

However, there is a drawback in that the flow of traffic may be interrupted if a vehicle violates a traffic signal.

### SUMMARY OF THE INVENTION

Embodiments of the present invention provide a system for apprehending traffic signal violators, which can automatically apprehend drivers violating traffic signals installed at intersections, thus promoting drivers to obey traffic signals and optimize traffic flow.

In accordance with a preferred embodiment of the present invention, a system for apprehending traffic signal violators comprises an on-board equipment (OBE) provided in a vehicle for transmitting the speed information and license plate number of the vehicle. A first roadside equipment (RSE) receives the speed information and the license plate number from the vehicle before the vehicle enters an intersection. A second RSE receives the speed information and license plate number from the vehicle after the vehicle enters the intersection. A signal light controller controls traffic signal lights at the intersection. A server center detects a vehicle violating a traffic signal on the basis of signals inputted from the first and second RSEs and the signal light controller. An automated camera performs a photographing operation according to the control of the server center and captures at least one image of the vehicle violating the traffic signal.

Preferably, the server center may compare the license plate numbers of the vehicles after the vehicles enter the intersection with the license plate numbers of the vehicles before the vehicles enter the intersection, determine the direction of the vehicles entering the intersection according to a result of the comparison, and determine whether or not a vehicle entering the intersection has violated the traffic signal by referring to the operating state of the traffic signal light.

Preferably, the server center may determine that the vehicle has unavoidably violated a traffic signal due to road congestion if the speed of the vehicle violating the traffic signal is equal to or lower than a predetermined speed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic illustration of a system for apprehending traffic signal violators in accordance with an embodiment of the present invention; and

FIG. 2 is a flowchart illustrating operation of a system for apprehending traffic signal violators in accordance with an embodiment of the present invention.

### DESCRIPTION OF THE PREFERRED EMBODIMENTS

The preferred embodiments of the present invention will now be described in detail with reference to the annexed drawings.

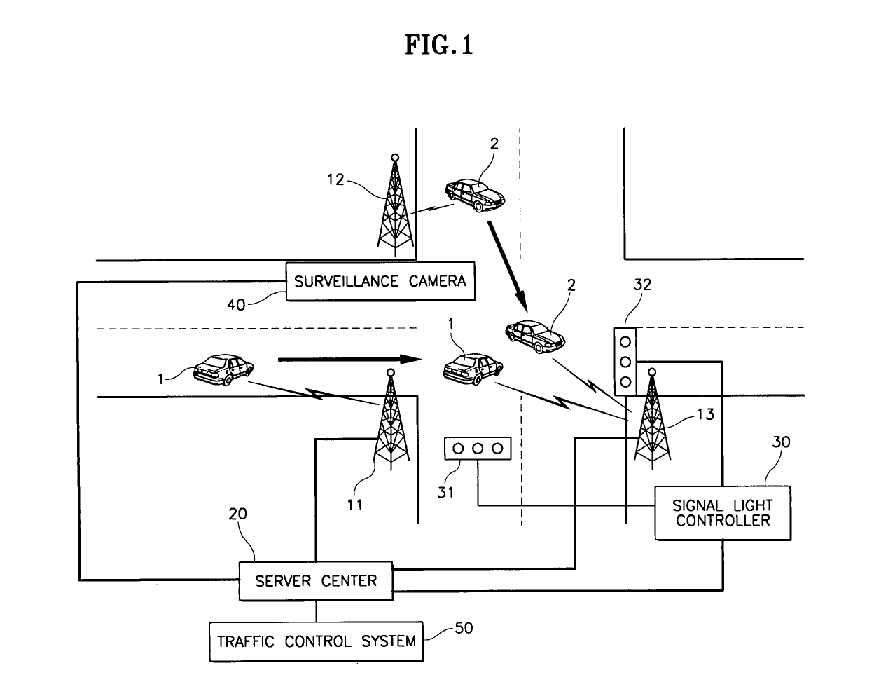

Referring to FIG. 1, vehicles 1 and 2 are equipped with on-board equipment (OBEs) OBE1 and OBE2, respectively. The OBEs (OBE1 and OBE2) transmit speed information and license plate numbers of the vehicles to roadside equipment (RSEs) 11, 12 and 13.

The first RSEs 11 and 12 receive the speed information and license plate numbers from OBE1 and OBE2 provided in the vehicles before the vehicles enter the intersection and then transmit the speed information and the license plate numbers to a server center 20. After the vehicles enter the intersection, the second RSE 13 receives the speed information and the license plate numbers from the OBE1 and OBE2 and then transmits the speed information and the license plate numbers to the server center 20.

While only two first RSEs 11 and 12 are shown in FIG. 1, but the quantity of first RSEs is not limited to two. For example, in preferred embodiments, four first RSEs are used at a four-way intersection, and three first RSEs are used at a three-way intersection. The OBEs and RSEs preferably include transceivers for radio communication between one another. In a preferred embodiment, the signal is broadcast at about 5.8 GHz. In such an embodiment, the transmission speed and distance of the OBE and RSE are 1 Mbps and 200 m respectively.

A signal light controller 30 controls traffic signal lights 31 and 32 installed at an intersection, and transmits signals indicating the operating states of the traffic signal lights 31 and 32 to the server center 20. In response to signals inputted from the first and second RSEs 11, 12 and 13, the server center 20 detects a vehicle violating the traffic signal and then stores the license plate number of the violating vehicle. Furthermore, the server center 20 enables an automated camera 40 to produce at least one image of the vehicle violating the traffic signal. The server center 20 transmits the produced image to a traffic control system 50 so that an authority such as a police department can enforce and prosecute traffic signal violations. The traffic control system 50 preferably is a computer system provided at an authority such as a police department that is authorized to issue traffic signal violations.

The server center 20 compares the vehicle license plate numbers after the vehicles enter the intersection with the vehicle license plate numbers before the vehicles enter the intersection, and determines the direction of the vehicles entering the intersection. Then, the server center 20 determines whether or not a vehicle entering the intersection has violated the traffic signal by referring to the operating state of the traffic signal light. However, if the speed of the vehicle violating the traffic signal is equal to or lower than a predetermined speed, the server center 20 determines that the vehicle has unavoidably violated the traffic signal due to, for example, road congestion.

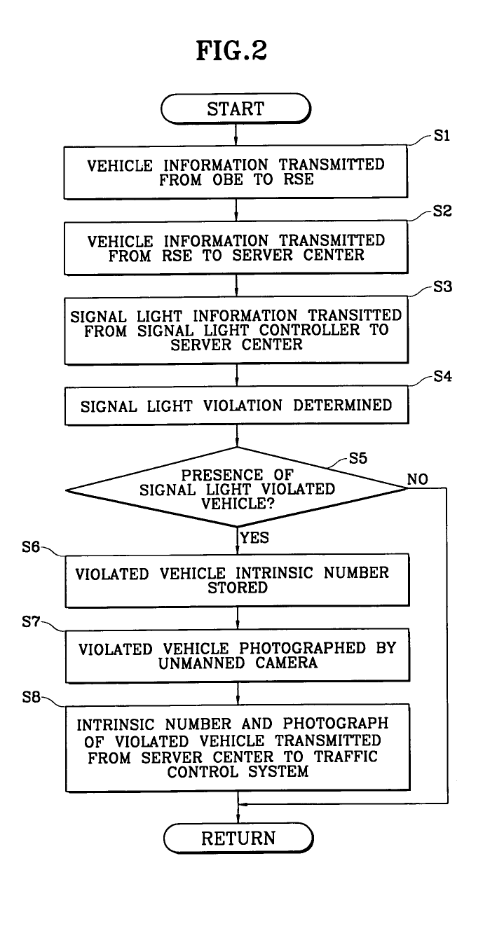

The operation and advantageous effects of the system for apprehending traffic signal violators in accordance with the present invention will now be described in detail with reference to FIG. 2.

As indicated in FIG. 2, the OBEs (OBE1 and OBE2) provided in the vehicles transmit the speed information and the license plate numbers of the vehicles 1 and 2 to the RSEs 11, 12 and 13 at step S1.

Then, the RSEs 11, 12 and 13 transmit the speed information and license plate numbers to the server center 20 at step S2. The first RSEs 11 and 12 receive the speed information and license plate numbers from the OBEs (OBE1 and OBE2) provided in the vehicles before the vehicles enter an intersection and then transmit the speed information and the license plate numbers to the server center 20. Furthermore, the second RSE 13 receives the speed information and license plate numbers from the OBEs (OBE1 and OBE2) after the vehicles enter the intersection, and then transmits the speed information and license plate numbers to the server center 20.

Then, the signal light controller 30 transmits signals indicating the operating states of the traffic signal lights 31 and 32 to the server center 20 at step S3.

Next, the server center 20 determines, at step S4, whether or not a vehicle has violated the traffic signal on the basis of signals inputted from the first and second RSEs 11, 12 and 13.

In other words, the license plate numbers of the vehicles after the vehicles enter the intersection are sequentially compared with the license plate numbers of the vehicles before the vehicles enter the intersection to find the identification number of the vehicle before the vehicle enters the intersection. According to a result of the comparison, the server center 20 determines the direction of the vehicles entering the intersection. The server center 20 then determines whether or not a vehicle entering the intersection has violated the traffic signal by referring to the operating state of the traffic signal light.

The server center 20 determines, at step S5, whether a vehicle violating the traffic signal is present, and the sever center 20 performs step S6 if the server center 20 detects a traffic signal violator. The server center 20 stores the license plate number of the vehicle violating the traffic signal in the above step S6. Next, the server center 20 enables a photographing operation of the automated camera 40 so that it can produce at least one image of the vehicle violating the traffic signal at step S7.

Finally, the license plate number and image of the violating vehicle are transmitted from the server center 20 to the traffic control system 50 at step S8 so that an authority such as the police department can enforce and prosecute the traffic signal violator.

As apparent from the above description, the present invention provides a system for apprehending traffic signal violators, which can automatically apprehend vehicles violating traffic signals at an intersection, etc., promote drivers to obey traffic signals and optimize traffic flow.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for apprehending vehicles violating a traffic signal, comprising:
on-board equipment (OBE) provided in vehicles for transmitting speed information and license plate numbers of the vehicles;
a first roadside equipment (RSEs) for receiving the speed information and the license plate numbers from the vehicle OBE before the vehicles enter an intersection;
a second RSE for receiving the speed information and license plate numbers from the vehicle OBE after the vehicles enter the intersection;
a signal light controller for controlling traffic signal lights at the intersection;
a server center for detecting a vehicle violating a traffic signal on the basis of signals inputted from the first and second RSEs and said signal light controller, and
an automated camera for performing a photographing operation according to the control of said server center and producing at least one image of the vehicle violating the traffic signal.

2. The system as set forth in claim 1, wherein said server center compares the license plate numbers of the vehicles after the vehicles enter the intersection with the license plate numbers of the vehicles before the vehicles enter the intersection, determines the direction of the vehicles entering the intersection according to a result of the comparison, and determines whether or not a vehicle entering the intersection has violated the traffic signal by referring to the operating state of the traffic signal light.

3. The system as set forth in claim 2, wherein said server center determines that the vehicle has unavoidably violated the traffic signal due to road congestion if a speed of the violating vehicle is equal to or lower than a predetermined speed.

4. The system as set forth in claim 1 further comprising a traffic control system for receiving, from said server center, the license plate number and image of the vehicle violating the traffic signal so that the violator can be prosecuted.
